(19) United States
(12) Patent Application Publication
(10) Pub. No.: US 2026/0228634 A1
(43) Pub. Date: Aug. 6, 2026

(54) Bias Reduction in Machine Learning Model Training and Inference

(71) Applicant: Epistamai, Inc., Apex, NC (US)

(72) Inventor: Christopher Lam, Apex, NC (US)

(21) Appl. No.: 19/576,661

(22) Filed: Mar. 24, 2026

Related U.S. Application Data
(63) Continuation-in-part of application No. 18/610,675, filed on Mar. 20, 2024.
Application No. 18/610,675 is a continuation-in-part of application No. 18/055,031, filed on Nov. 14, 2022, now Pat. No. 11,966,826.
Application No. 18/055,031 is a continuation of application No. 18/051,134, filed on Oct. 31, 2022.
(60) Provisional application No. 63/365,905, filed on Jun. 6, 2022.

(51) Int. Cl. G06N 20/00

(52) U.S. Cl. CPC G06N 20/00

(57) ABSTRACT

A computer-implemented method may be used to reduce bias in machine learning predictions. Training data including target values, feature values, and protected attribute values is received. Based on the protected attribute values, the training data is partitioned into multiple groups, each associated with a different protected attribute value or combination of values, and corresponding partition weights are determined. A partitioned supervised machine learning model is trained by training separate model portions on the observations assigned to the respective partitions. During inference, an observation including feature values is received and evaluated by each model portion to generate multiple predicted outcome values corresponding to different protected attribute scenarios. These predicted outcome values are then combined using the partition weights to determine a weighted predicted outcome value, which is stored or output for use in controlling a downstream decision process.

### CROSS-REFERENCE TO RELATED APPLICATIONS

This application is a continuation-in-part of U.S. patent application Ser. No. 18/610,675 (Attorney Docket CRLBP001USC1X1), filed Mar. 20, 2024 by Christopher Lam, titled “BIAS REDUCTION IN MACHINE LEARNING MODEL TRAINING AND EXECUTION,” which is a continuation-in-part of U.S. patent application Ser. No. 18/055,031 (Attorney Docket CRLBP001USC1), filed Nov. 14, 2022 by Christopher Lam, titled “BIAS REDUCTION IN MACHINE LEARNING MODEL TRAINING AND EXECUTION,” which is a continuation of U.S. patent application Ser. No. 18/051,134 (Attorney Docket CRLBP001US), filed Oct. 31, 2022 by Christopher Lam, titled “BIAS REDUCTION IN MACHINE LEARNING MODEL TRAINING AND INFERENCE,” which claims priority to provisional U.S. Patent Application No. 63/365,905 (Attorney Docket CRLBP001P), filed Jun. 6, 2022 by Christopher Lam, titled “BIAS REDUCTION IN MACHINE LEARNING MODEL TRAINING AND EXECUTION,” all of which are hereby incorporated by reference in their entirety and for all purposes.

### FIELD OF TECHNOLOGY

This patent document relates generally to machine learning and more specifically to bias reduction in machine learning.

### BACKGROUND

Machine learning algorithms are applied to solve prediction problems in a variety of contexts. In a conventional machine learning approach, data is used to train a prediction model in a training phase. The trained prediction model may then be used to predict unobserved outcomes in an inference phase. A significant problem in machine learning is algorithmic bias, a topic that has recently received enormous attention, with high profile examples of discrimination in criminal justice, facial recognition, employment screening, and advertising.

Algorithmic bias refers to situations in which an algorithm is trained in a way that biases the algorithm against individuals based on protected characteristics. For example, a class of people who have historically and/or currently faced discrimination in a society may be treated differently and hence obtain worse outcomes in areas such as credit, employment, and the like through structural discrimination alone, irrespective of personal choices and characteristics. A machine learning model trained to predict these outcomes based on data that includes information that could identify an individual as belonging to such a class may therefore inadvertently reinforce discrimination by effectively predicting negative outcomes based on membership in the class. Accordingly, improved techniques for training and executing accurate prediction models while reducing algorithmic bias are desired.

### SUMMARY

In some embodiments, the techniques described herein relate to a computer-implemented method for reducing bias in machine learning predictions, the method including: receiving, by one or more processors, training data including a plurality of training observations, each training observation including (i) a target value, (ii) a plurality of feature values corresponding to a plurality of features, and (iii) at least one protected attribute value corresponding to at least one protected attribute; determining, based on the at least one protected attribute value, a plurality of partitions of the training data and a corresponding plurality of partition weights, each partition corresponding to a different protected attribute value or combination of protected attribute values; training, using the plurality of partitions, a partitioned supervised machine learning model that includes a plurality of model portions respectively associated with the plurality of partitions, wherein each model portion is trained on training observations assigned to the corresponding partition; receiving an inference observation including a plurality of inference feature values corresponding to the plurality of features; applying the plurality of model portions to the inference observation to determine a plurality of predicted outcome values for the inference observation, each predicted outcome value being generated by a different one of the plurality of model portions and corresponding to evaluation of the inference observation with respect to a different protected attribute scenario represented by the corresponding partition; determining, based on the plurality of predicted outcome values and the plurality of partition weights, a weighted predicted outcome value for the inference observation, wherein the weighted predicted outcome value is determined by combining the plurality of predicted outcome values according to the plurality of partition weights such that the weighted predicted outcome value reflects contributions from the different protected attribute scenarios; and storing or outputting the weighted predicted outcome value for use in controlling a downstream decision process.

In some embodiments, the techniques described herein relate to a method, wherein determining the plurality of partitions includes defining each partition based on a distinct value of at least one protected attribute.

In some embodiments, the techniques described herein relate to a method, wherein determining the plurality of partitions includes defining at least some partitions based on combinations of values of two or more protected attributes.

In some embodiments, the techniques described herein relate to a method, wherein the plurality of partition weights are determined based on relative frequencies of the corresponding partitions within the plurality of training observations.

In some embodiments, the techniques described herein relate to a method, wherein the plurality of partition weights are determined based on externally supplied demographic information corresponding to a population associated with the machine learning predictions.

In some embodiments, the techniques described herein relate to a method, wherein determining the weighted predicted outcome value includes determining a weighted average of the plurality of predicted outcome values using the plurality of partition weights.

In some embodiments, the techniques described herein relate to a method, wherein training the partitioned supervised machine learning model includes training each model portion using only training observations associated with the corresponding partition.

In some embodiments, the techniques described herein relate to a method, wherein the protected attribute corresponds to at least one of race, ethnicity, gender, age, disability status, national origin, or religion.

In some embodiments, the techniques described herein relate to a method, wherein the downstream decision process corresponds to at least one of determining whether to extend credit, determining whether to admit an applicant to an educational institution, determining whether to extend an employment offer, or determining a pricing or risk assessment associated with an individual.

In some embodiments, the techniques described herein relate to a method, wherein determining the plurality of partitions further includes aggregating two or more protected attribute values into a common partition when a number of training observations associated with at least one of the protected attribute values falls below a designated threshold.

In some embodiments, the techniques described herein relate to a method, wherein determining the plurality of partition weights includes adjusting at least one partition weight to increase a contribution of a partition associated with a historically disadvantaged protected attribute group.

In some embodiments, the techniques described herein relate to a method, wherein applying the plurality of model portions to the inference observation includes generating predicted outcome values corresponding to hypothetical assignments of the inference observation to different protected attribute values.

In some embodiments, the techniques described herein relate to a method, wherein the partitioned supervised machine learning model includes at least one of a regression model, a decision tree model, a gradient boosting model, a neural network model, or an ensemble model.

In some embodiments, the techniques described herein relate to a method, further including normalizing the plurality of predicted outcome values prior to determining the weighted predicted outcome value.

In some embodiments, the techniques described herein relate to a system including one or more processors configured to perform a method for reducing bias in machine learning predictions, the method including: receiving, by the one or more processors, training data including a plurality of training observations, each training observation including (i) a target value, (ii) a plurality of feature values corresponding to a plurality of features, and (iii) at least one protected attribute value corresponding to at least one protected attribute; determining, based on the at least one protected attribute value, a plurality of partitions of the training data and a corresponding plurality of partition weights, each partition corresponding to a different protected attribute value or combination of protected attribute values; training, using the plurality of partitions, a partitioned supervised machine learning model that includes a plurality of model portions respectively associated with the plurality of partitions, wherein each model portion is trained on training observations assigned to the corresponding partition; receiving an inference observation including a plurality of inference feature values corresponding to the plurality of features; applying the plurality of model portions to the inference observation to determine a plurality of predicted outcome values for the inference observation, each predicted outcome value being generated by a different one of the plurality of model portions and corresponding to evaluation of the inference observation with respect to a different protected attribute scenario represented by the corresponding partition; determining, based on the plurality of predicted outcome values and the plurality of partition weights, a weighted predicted outcome value for the inference observation, wherein the weighted predicted outcome value is determined by combining the plurality of predicted outcome values according to the plurality of partition weights such that the weighted predicted outcome value reflects contributions from the different protected attribute scenarios; and storing or outputting the weighted predicted outcome value for use in controlling a downstream decision process.

In some embodiments, the techniques described herein relate to a system, wherein determining the plurality of partitions includes defining each partition based on a distinct value of at least one protected attribute.

In some embodiments, the techniques described herein relate to a system, wherein determining the plurality of partitions includes defining at least some partitions based on combinations of values of two or more protected attributes.

In some embodiments, the techniques described herein relate to a system, wherein the plurality of partition weights are determined based on relative frequencies of the corresponding partitions within the plurality of training observations.

In some embodiments, the techniques described herein relate to a system, wherein the plurality of partition weights are determined based on externally supplied demographic information corresponding to a population associated with the machine learning predictions.

In some embodiments, the techniques described herein relate to one or more non-transitory computer readable media having instructions stored thereon for performing a method for reducing bias in machine learning predictions, the method including: receiving, by one or more processors, training data including a plurality of training observations, each training observation including (i) a target value, (ii) a plurality of feature values corresponding to a plurality of features, and (iii) at least one protected attribute value corresponding to at least one protected attribute; determining, based on the at least one protected attribute value, a plurality of partitions of the training data and a corresponding plurality of partition weights, each partition corresponding to a different protected attribute value or combination of protected attribute values; training, using the plurality of partitions, a partitioned supervised machine learning model that includes a plurality of model portions respectively associated with the plurality of partitions, wherein each model portion is trained on training observations assigned to the corresponding partition; receiving an inference observation including a plurality of inference feature values corresponding to the plurality of features; applying the plurality of model portions to the inference observation to determine a plurality of predicted outcome values for the inference observation, each predicted outcome value being generated by a different one of the plurality of model portions and corresponding to evaluation of the inference observation with respect to a different protected attribute scenario represented by the corresponding partition; determining, based on the plurality of predicted outcome values and the plurality of partition weights, a weighted predicted outcome value for the inference observation, wherein the weighted predicted outcome value is determined by combining the plurality of predicted outcome values according to the plurality of partition weights such that the weighted predicted outcome value reflects contributions from the different protected attribute scenarios; and storing or outputting the weighted predicted outcome value for use in controlling a downstream decision process.

### BRIEF DESCRIPTION OF THE DRAWINGS

The included drawings are for illustrative purposes and serve only to provide examples of possible structures and operations for the disclosed inventive systems, apparatus, methods and computer program products for bias reduction in machine learning model training and execution. These drawings in no way limit any changes in form and detail that may be made by one skilled in the art without departing from the spirit and scope of the disclosed implementations.

FIG. 1 illustrates an example of a machine learning model overview method, performed in accordance with one or more embodiments.

FIG. 2 illustrates an example of a model representation, configured in accordance with one or more embodiments.

FIG. 3A, FIG. 3B, FIG. 3C, FIG. 3D, FIG. 3E, and FIG. 3F are diagrams that illustrate various types of causal relationships, generated in accordance with one or more embodiments.

FIG. 4 illustrates an example of a method for training a prediction model, performed in accordance with one or more embodiments.

FIG. 5A, FIG. 5B, FIG. 5C, FIG. 5D, and FIG. 5E represent diagrams illustrating how prediction models may be used to predict a target variable, generated in accordance with one or more embodiments.

FIG. 6 illustrates an example of a method for preprocessing supervised machine learning data, performed in accordance with one or more embodiments.

FIG. 7 illustrates an example of a method for evaluating a supervised machine learning model, performed in accordance with one or more embodiments.

FIG. 8 illustrates an example of a method for applying a prediction model, performed in accordance with one or more embodiments.

FIG. 9 illustrates one example of a computing device, configured in accordance with one or more embodiments.

FIG. 10 illustrates one example of a supervised machine learning model partitioned training method, performed in accordance with one or more embodiments.

FIG. 11 illustrates one example of a supervised machine learning model partitioned inference method, performed in accordance with one or more embodiments.

### DETAILED DESCRIPTION

Various personal attributes may be used to predict future success in higher education, employment, or credit. Such prediction models may then be used to assist in making determinations such as whether to admit a person to an educational institution, whether to extend an offer of employment, or whether to extend an offer of credit. However, some personal attributes such as race or gender may be considered as inappropriate, as their use in prediction models may result in impermissible or undesired bias against particular classes of people.

Accordingly, many models omit such attributes.

Even when protected attributes are omitted from prediction models, non-protected attributes such as educational institution or personal residence postal zip code may strongly predict one or more protected attributes such as race or gender. For example, having knowledge that an applicant previously attended a historically Black college or university (HBCU) could inform the model that the applicant is most likely Black. Then, despite possessing characteristics otherwise comparable to creditworthy individuals of other races, the applicant having attended an HBCU may be discriminated against, to the extent that being Black correlates with credit default. For this reason, the use of some otherwise non-protected data in a prediction model can create a source of confounder bias along a protected attribute inside the model. That is, models using certain types of otherwise non-protected data may cause overt, intentional discrimination (i.e., disparate treatment), even though the protected attribute is not directly used in the model. Accordingly, even non-protected attributes are omitted from many prediction models. However, such omissions may weaken the predictive power of the model. For instance, an applicant's zip code may be omitted from a model because it can be highly predictive of race (due to redlining), despite the fact that zip code can also provide powerfully predictive information about an applicant's likelihood of default that is entirely unrelated to race (for example, living in a Rust Belt zip code versus a Sun Belt zip code).

Techniques and mechanisms described herein provide for the reduction or elimination of some types of bias in machine learning models. A supervised machine learning process may be modeled as a casual Bayesian network. A set of training data that includes observed outcome values, observed predictor values, and observed protected attribute values are used to train the prediction model in a training phase. One or more performance metrics may be determined and used to evaluate the trained model and improve the training process. Then, to predict one or more unobserved outcome values, the trained prediction model may be applied to inference data. The inference data may either omit the protected attribute entirely or may include default values substituted for actual values associated with the protected attribute.

In some implementations, techniques and mechanisms described herein may significantly improve the predictive quality of some prediction models by allowing for the use of new sources of data while reducing or eliminating unacceptable or impermissible bias that would result from the use of such new data sources in connection with conventional techniques.

According to various embodiments, techniques and mechanisms described herein may be used to address disparate treatment, a particular type of discrimination that is conceptually and often legally distinct from disparate impact. That is, a difference in decisions across groups (i.e., disparate impact) does not necessarily imply that a prediction model treats people in the groups differently (i.e., disparate treatment). For instance, a model in which women are on average are predicted to be somewhat less creditworthy than men may not be deemed discriminatory when the result merely reflects differences between the two groups in characteristics such as income.

However, a model in which a woman is deemed less creditworthy than a man despite the two observations being generally comparable in characteristics other than gender may be deemed unfairly discriminatory.

According to various embodiments, techniques and mechanisms described herein may also be used to address disparate impact, which refers to practices that adversely affect one group of people of a protected characteristic more than another, even though the practices do not explicitly take one's membership in a protected group into account. For example, a model that doesn't explicitly take into account race but has a tendency to overpredict the probability of default for members of an unprivileged group compared to members of a privileged group. In this case, we may want the model to explicitly take into account race to provide a less discriminatory outcome for the unprivileged group.

Many conventional approaches to addressing bias in machine learning have relied on statistical or correlational approaches that measure disparities in outcomes across groups. However, such approaches have significant limitations because discrimination is based on causation, not correlation. Accordingly, such conventional approaches often result in models with relatively limited predictive power. In contrast, some techniques and mechanisms described herein are based on a causal, Bayesian analysis rather than a statistical or correlational approach, thus avoiding these problems.

Other conventional approaches to addressing bias in machine learning have attempted to adopt a causal approach. However, such approaches typically provide only a partial model of fairness and discrimination that do not entirely address the problem. Moreover, such approaches typically require complex modeling of causal relationships, rendering the solutions unclear as to whether or not disparate treatment has been eliminated. In contrast, techniques and mechanisms described herein model the entire supervised machine learning process itself as a causal Bayesian network, thus providing a way to build a complete model of fairness and discrimination. Thus, techniques and mechanisms described herein provide for the reduction or elimination of confounder bias from a supervised machine learning model.

According to various embodiments, techniques and mechanisms described herein may be used to address discrimination across a variety of dimensions. Examples of such dimensions may include, but are not limited to: race, ethnicity, sex, gender, sexual orientation, transgender status, national origin, religion, disability status, age, skin color, genetic information, marital status, and receipt of public assistance.

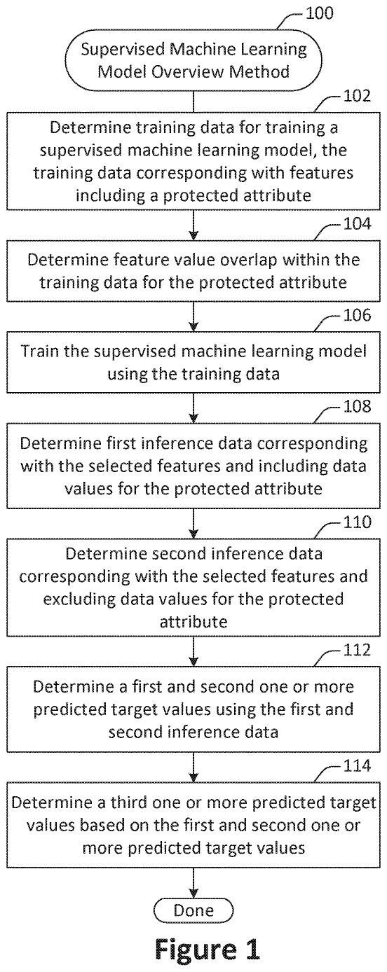

FIG. 1 illustrates an example of an arrangement of a supervised machine learning model overview method 100, performed in accordance with one or more embodiments. According to various embodiments, the method 100 may be performed on one or more computing devices to train a machine learning model and then use the trained model to predict one or more unobserved outcome values in a way that reduces bias based on one or more protected attributes.

Training data for training a supervised machine learning model is determined at 102. According to various embodiments, the training data includes a set of observations that each corresponds with a unit of analysis, such as an individual. Each observation includes a number of data values that correspond with features, including one or more protected attributes.

Feature overlap within the training data for the protected attribute or attributes is determined at 104. According to various embodiments, the feature overlap may identify a degree to which particular values of a protected attribute overlap with particular values or combinations of values of other features. For example, some colleges have historically restricted admission to either men or women. A college to which only women have been admitted would therefore overlap entirely with a value of “female” for the feature “gender”, which in some models may be considered a protected attribute. The lack of overlap for “gender” with “male” for students who attend that college could also be called a positivity violation.

According to various embodiments, a protected attribute may be any feature for which bias is to be removed. Values corresponding with the protected attribute may be included when training the supervised machine learning model. Values corresponding with the protected attribute may then be omitted or replaced with default values during the inference phase. It should be noted that an attribute considered as protected in one model may not be considered as protected in a different model.

A machine learning model is trained at 106 using the training data. According to various embodiments, the particular operations performed to train the model may depend in part on the type of model being trained. For instance, the model may be a neural network model, regression model, gradient boosting machine, tree-based model, ensemble model, or other type of model.

First inference data including one or more observed predictor values is determined at 108. According to various embodiments, the first inference data may include observations similar to those included in the training phase except that the target values have not yet been observed. In some implementations, the first inference data may include observed protected attribute values.

Second inference data including one or more observed predictor values is determined at 108. According to various embodiments, the second inference data may be substantially similar to the first inference data except that the second inference data may simply omit the protected attribute values entirely. Alternatively, the second inference data may include substituted protected attribute values.

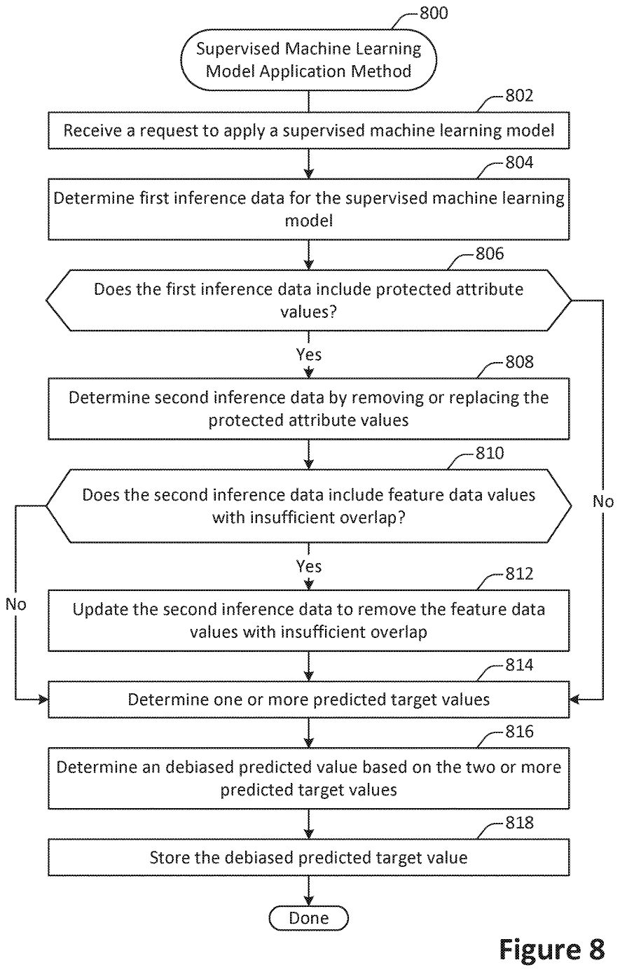

A first and a second one or more predicted target values are predicted at 112 by applying the machine learning model to the first and second inference data. Additional details regarding the determination of inference data and the application of the trained machine learning model to inference data are described with respect to the method 800 shown in FIG. 8.

A third one or more predicted target values are determined at 114 based on the first and second one or more predicted target values. In some implementations, an observation may have only a single predicted target value. For instance, if the observation has an actual protected attribute value that is identical to the default protected attribute value substituted at operation 110 when constructing the second inference data, then the observation would be the same in the first and second inference data, leading to the same predicted target value for the observation in both the first and second one or more predicted attribute values. In such a situation, the third one or more predicted target value for the observation would be the same as the first and second predicted target value for the observation.

In some embodiments, an observation may have a different predicted target value in the first inference data and the second inference data. For instance, if the actual protected attribute value for the observation in the first inference data was substituted at 110 for a different, default protected attribute value when determining the second inference data, then different predicted target values for the observation may be determined by applying the prediction model to the first and second inference data. In such a situation, the third predicted target value may be determined based on one or more predetermined rules. For example, the target value for an observation that is least discriminatory may be selected. For instance, in a loan application or college admission context, the target value that is most favorable to the applicant represented by the observation may be selected. As another example, the different target values for an observation may be combined in some fashion, for instance by averaging them.

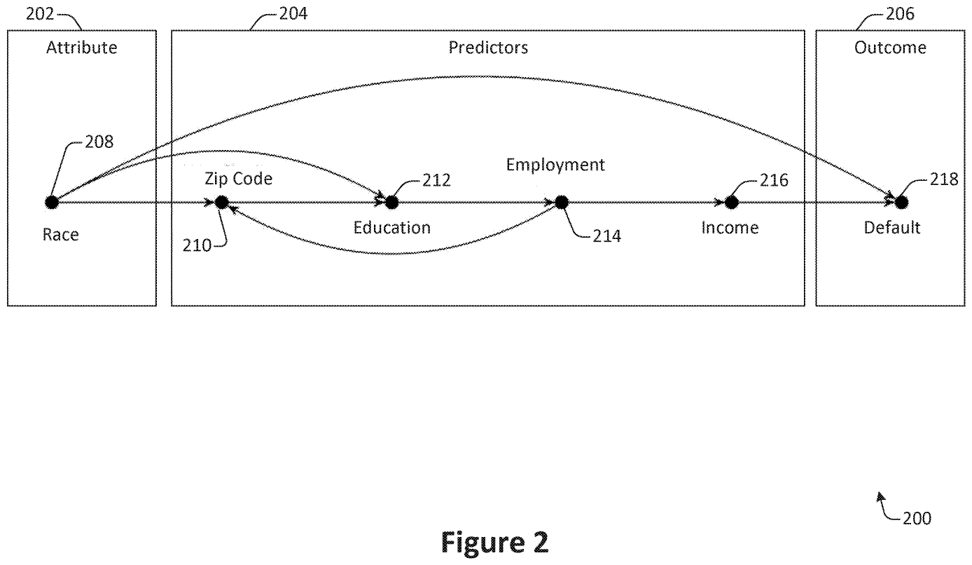

FIG. 2 illustrates an example of a model representation 200, configured in accordance with one or more embodiments. FIG. 2 illustrates causal relationships represented by arrows between observable data values represented by dots. The model representation 200 illustrates an example of how a protected attribute such as race could be causally related to a target variable such as credit default or criminal recidivism.

In FIG. 2, a person's Race can influence the Zip Code that the person lives in, which can then influence the person's access to Education, which can then influence their Employment opportunities, which can then influence their Income, which can then influence their probability of Default on a loan. In addition, a person's race may directly affect their education opportunities (e.g., via discrimination, or a decision to attend a particular university). Also, Employment opportunities 214 may affect a person's Zip Code 210, for instance if the person decides to move to pursue a new job. Finally, a direct connection may exist between Race 208 and Default 218. Such a connection does not indicate that a person's Race directly causes Default, since it could be completely mediated or explained away by other creditworthiness factors. Rather, it instead indicates only that a different causal pathway exists apart from the path from Zip Code 210 to Default 218 that is not represented in the model, for instance via family wealth. For this reason, in many contexts an attribute such as Race is treated as protected and excluded from the model, since its inclusion could lead the model to generate discriminatory predictions.

According to various embodiments, one challenge in machine learning is that models such as that shown in FIG. 2 are difficult to analyze because they contain loops such as the loop from Zip Code 210 to Education 212 to Employment 214 and back to Zip Code 210. Another challenge may be that non-protected attributes such as Zip Code may act as a proxy for a protected attribute such as Race. For example, consider a model in which a protected attribute 202 is omitted from both training and inference but the other predictors 204 are retained. Such an approach may not address the bias problem since a person's Zip Code 210 may act as a proxy for Race 208, leading to similar bias.

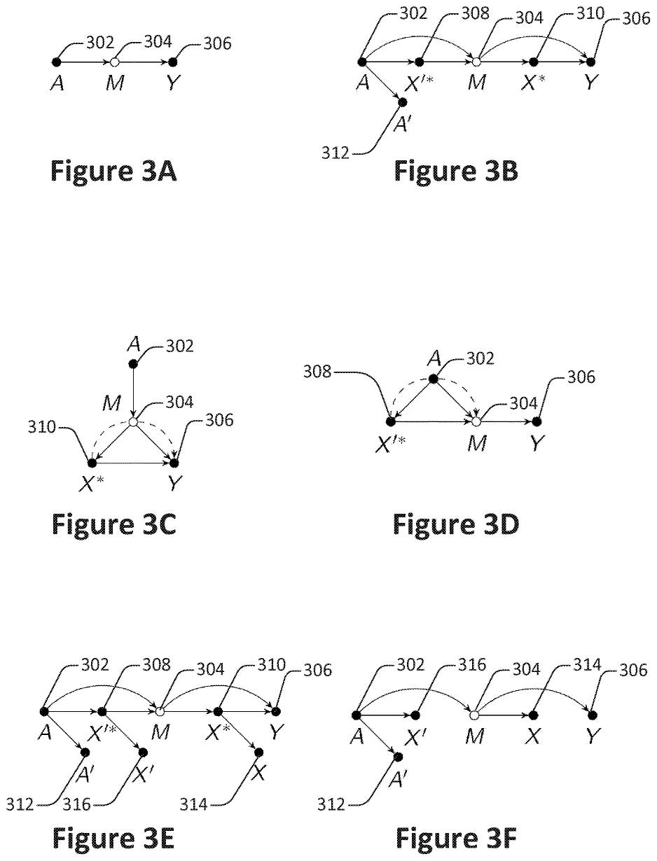

FIG. 3A, FIG. 3B, FIG. 3C, FIG. 3D, FIG. 3E, and FIG. 3F are diagrams that illustrate various types of causal relationships, generated in accordance with one or more embodiments.

In FIG. 3A, A 302 represents a protected attribute, such as race or gender, while Y 306 represents a target variable, such as default on a loan. Although the protected attribute 302 may have some correlation with the target variable Y 306, we assume that there is a mediating construct M 304, such as creditworthiness, that explains away this relationship in a causal sense. That is, conditional on the mediating construct M 304, the protected attribute A 302 and the target variable Y 306 are independent. Put another way, the mediating construct M 304 d-separates A 302 from Y 306.

In FIG. 3B, protected attribute pure proxies A′ 312 purely proxies for the protected attribute A 302 and are removed from the set of features used in both training and inference. For instance, hair length may proxy for gender but may have no relevance to predicting creditworthiness. In some implementations, protected attribute pure proxies A′ 312 may be removed manually. Alternatively, or additionally, one or more protected attribute pure proxies A′ 312 may be removed during the training phase. For instance, features that have low predictive power but that are highly correlated with values corresponding with the protected attribute A 302 may be automatically removed.

In addition, FIG. 3B also introduces traditional features X* 310 and alternative features X′* 308. The traditional features X* 310 includes any features that measure or proxy for the mediating construct M 304. For instance, income may be considered a proxy for creditworthiness. The alternative features X′* 308 includes any features that may affect the mediating construct M 304 but that may also be seen as proxying for the protected attribute A 302 due to confounder bias. For instance, zip code may partially predict credit worthiness but may also proxy for a protected attribute such as race.

According to various embodiments, the traditional features X* 310 represents data traditionally used to predict the target variable Y 306. As shown in FIG. 3C, the target variable Y 306 may be predicted directly by the traditional features X* 310, by the mediating construct M 304, and spuriously by the traditional features X* 310 through the mediating construct M 304. For instance, higher income may be directly indicative of an ability to pay off a loan. At the same time, higher income may be spuriously indicative of creditworthiness (such as having more financial assets), which may also in turn lead to higher income. However, in FIG. 3C, the protected attribute A only affects the target variable Y 306 via the mediating construct M 304. Therefore, X* 310 does not act as a proxy for A 302, even if X* 310 is correlated with A 302.

According to various embodiments, the alternative features X′* 308 represents data that is not traditionally used to predict the target variable Y 306. As shown in FIG. 3D, the mediating construct M 304 may be predicted directly by the alternative features X′* 308, directly by the protected attribute A 302, and spuriously by the alternative features X′* 308 through the protected attribute A 302. Further, the protected attribute A may also directly predict the alternative features X′*. For example, race may directly predict zip code and credit worthiness. Zip code may also be directly indicative of creditworthiness (such as having more financial assets). However, zip code may also spuriously predict creditworthiness through race.

As shown in FIG. 3E, the mediating construct M 304 is assumed to completely explain any relationship between the protected attribute A 302 and the target variable Y 306, as well as between the alternative features X′* 308 and the target variable Y 306. The alternative features X′* 308 may indirectly predict the target variable Y 306 through the mediating construct M 304. However, the alternative features X′* 308 may also spuriously predict the target variable Y 306 by proxying for the protected attribute A 302. For example, a particular zip code may be indicative of wealth and thereby predict credit worthiness. However, a particular zip code may also be a proxy for race. For this reason, models predicting creditworthiness traditionally exclude zip code as a feature to avoid inadvertently discriminating against people of a particular race (e.g., via redlining).

FIG. 3E and FIG. 3F introduce traditional feature data X 314 and alternative feature data X′ 316. As discussed with respect to protected attribute A 302 in FIG. 3B, the traditional features X* 310 and the alternative features X*′ 308 are imperfectly measured by traditional feature data X 314 and alternative feature data X′ 316. For example, in a prediction model a person's income may be self-reported or proxied based on an estimate or range. Accordingly, in FIG. 3E and FIG. 3F, although the traditional feature data X 314 and alternative feature data X′ 316 do not directly cause the mediating construct M 304 and the target variable Y 306, they may nevertheless be used in training and inference data sets.

According to various embodiments, techniques and mechanisms described herein may be applied to textual data. For instance, text sources such as a loan application, resume, voice interview recording, or other such source of textual data may be analyzed to identify textual data. The textual data may then be cleaned by applying operations such as parsing, tokenization, removal of stop words, and the like.

In some embodiments, a bag-of-words or n-gram approach may be used to tokenize the textual data into individual words and phrases. Some or all of these words and phrases may then be used to predict an outcome such as job performance or loan default. However, some words and phrases, such as “women” and “God bless”, act as pure proxies A′ 312 and would be removed from the model. Other words like “executed” and “captured” (which are more frequently used by men on their resumes) may be highly correlated with protected attributes such as sex but still have a direct effect on the target variable Y 306. Accordingly, some words and phrases may be treated in the model in a manner similar to zip code or other such features that are correlated with protected classes.

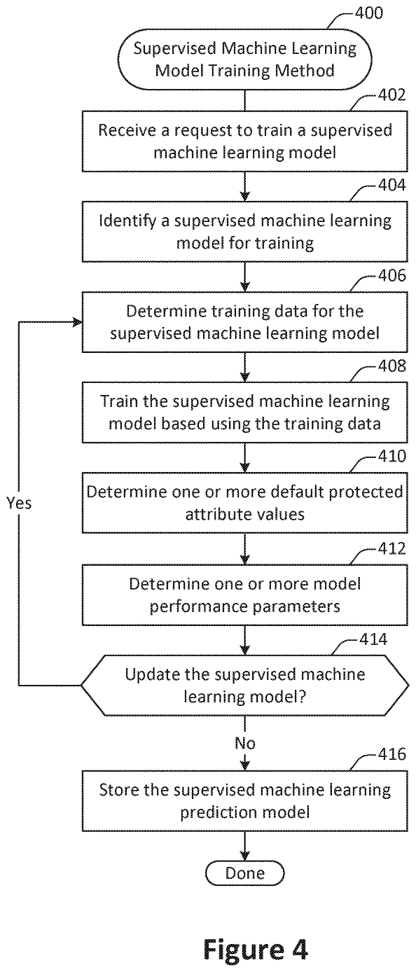

FIG. 4 illustrates an example of a method 400 for training a supervised machine learning model, performed in accordance with one or more embodiments. According to various embodiments, the method 400 may be implemented on any suitable computing device.

A request to train a supervised machine learning model, which is also referred to herein as a prediction model, is received at 402. According to various embodiments, the request may be generated manually or automatically. The request may include some or all of the information identified in FIG. 4, such as target value data and training data. Alternatively, or additionally, the request may identify or refer to such information.

A supervised machine learning model is identified for training at 404. According to various embodiments, any of a variety of supervised machine learning models may be employed. Examples of suitable machine learning models include, but are not limited to: decision trees, tree-based models, gradient boosting models, deep learning models, neural networks, and regression models.

Training data for the prediction model are identified at 406. The training data may include data identifying target values to predict, protected attribute data values, data values corresponding to traditional features used to predict the target values, and data values corresponding to alternative features used to predict the target values.

According to various embodiments, the training data may be divided into a plurality of observations. For example, an observation may correspond to an individual, an organization, or any other suitable unit of analysis. Each observation may in turn be associated with one or more protected attribute values, one or more values corresponding with traditional features, one or more values corresponding with alternative features, and one or more target values.

In some embodiments, target values may correspond to any values a supervised machine learning model may be trained for predict. For example, outcome values may include, but are not limited to, criminal recidivism, professional performance, educational performance, and credit default. In general, target values may be observable for historical data, to aid in training the supervised machine learning model. However, target values may be unobserved during the inference phase, at least at the time of inference.

According to various embodiments, target values may include discrete or continuous variables. For example, a discrete target value may be whether a loan applicant will default on a loan, while a continuous target variable may be an interest rate for a loan or a purchase price for an asset such as a house.

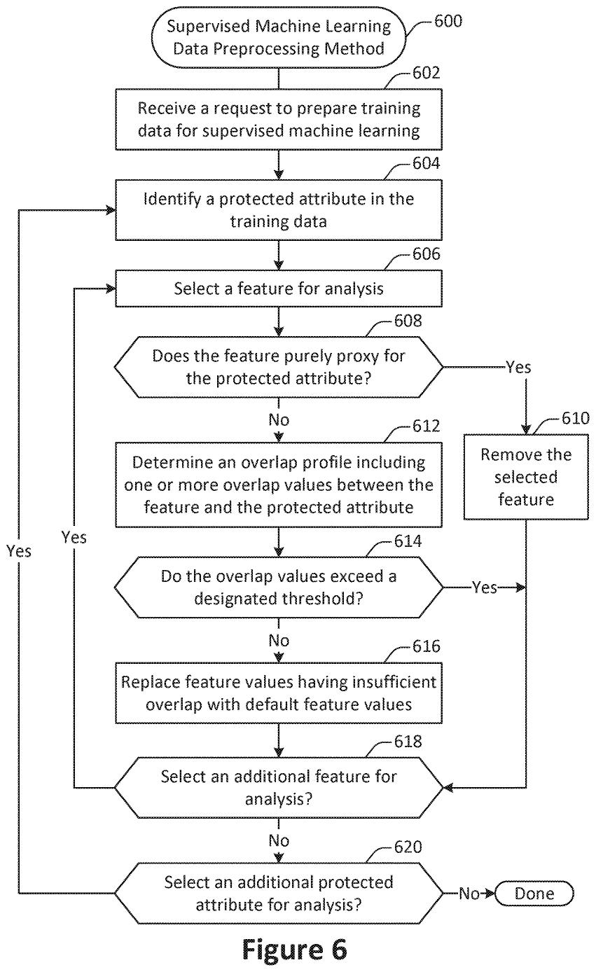

In some embodiments, traditional and alternative feature data values may correspond to any values not identified as an outcome value or a protected attribute value that are observable before the corresponding outcome value. Feature data values may indicate or measure characteristics such as education level, education performance, professional experience, income, age, location of residence, and/or any other relevant information used for the purpose of training and applying a machine learning model. It should be noted that the status of a variable as a feature or a protected attribute might differ, for instance depending on the application. For example, age may be considered a feature in some applications but a protected attribute in other applications. Additional details for determining training data for the supervised machine learning model are discussed with respect to the method 600 shown in FIG. 6.

In some embodiments, one or more values in the training data may be imputed. For example, a protected attribute value for an observation may be missing in the training data. Such missingness may be due to lack of availability. Alternatively, a value may be missing because its collection is prohibited by law. In such situations, the imputation technique may infer a suitable value. For example, a technique such as Bayesian Improved Surname Geocoding (BISG) may be used to infer a value for a protected attribute such as race or ethnicity based on a person's last name and zip code.

The supervised machine learning model is trained at 408 using the training data.

According to various embodiments, the particular operations employed to train the supervised machine learning model may depend in significant part on the prediction model employed. In some configurations, the scikit-learn Python package may be used for example to train the supervised machine learning model.

One or more default protected attribute values are determined at 410. According to various embodiments, the default protected attribute values may be used during the test and inference phases to replace actual protected attribute values. Various approaches may be used to determine default protected attribute values. For example, protected attribute values may be dropped completely and treated as missing. As another example, protected attribute values may be replaced with a single value for all observations. For instance, in a data set in which each observation corresponds to a person, the race of each individual may be set to a default value (e.g., Black, White, etc.), while the gender of each individual may be set to a default value (e.g., female, male, etc.). In this way, the actual race and gender of an individual may be masked during the test and inference phases so that it may not generate disparate treatment bias.

One or more model performance parameters are determined at 412. According to various embodiments, the model performance parameters may include one or more parameters related to the predictive performance of the supervised machine learning model. For instance, the model performance parameters may include one or more of accuracy, lift, precision, recall, or area under a receiver operator curve (AUC).

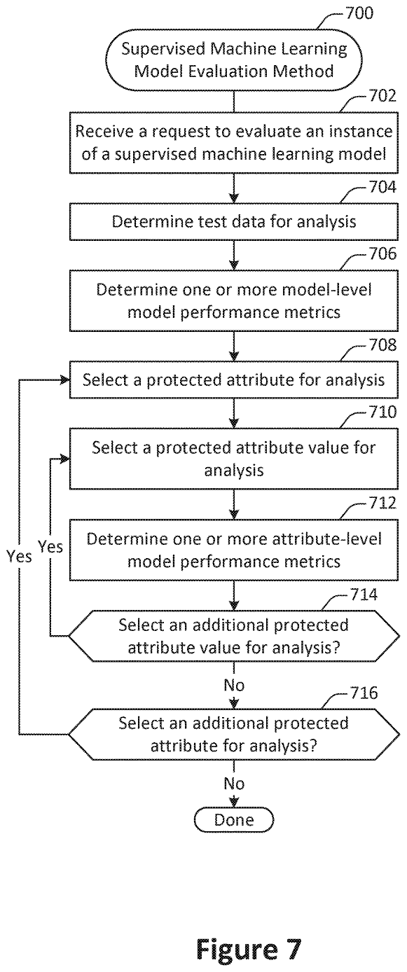

In some implementations, the model performance parameters may include one or more parameters related to bias. For example, the model performance parameters may compare a predicted outcome rate for members of a protected attribute value class under one or more variations of the model. As another example, the model performance parameters may compare a predictive performance of the model for particular values of a protected attribute. Additional details regarding the determination of model performance parameters are discussed with respect to the method 700 shown in FIG. 7.

A determination is made at 414 as to whether to update the supervised machine learning model. In some implementations, the supervised machine learning model may continue to be updated until one or more termination criteria are met. Such criteria may include, but are not limited to: a designated number of iterations, a designated level of predictive performance, a designated level of increase in predictive performance.

The supervised machine learning model is stored on a storage device at 416. In some implementations, storing the supervised machine learning model may involve storing one or more weights or values suitable for use in applying the supervised machine learning model to novel data. For example, in a regression model, storing the supervised machine learning model may involve storing regression coefficients. As another example, in a neural network model, storing the supervised machine learning model may involve storing weights associated with various neurons in the neural network.

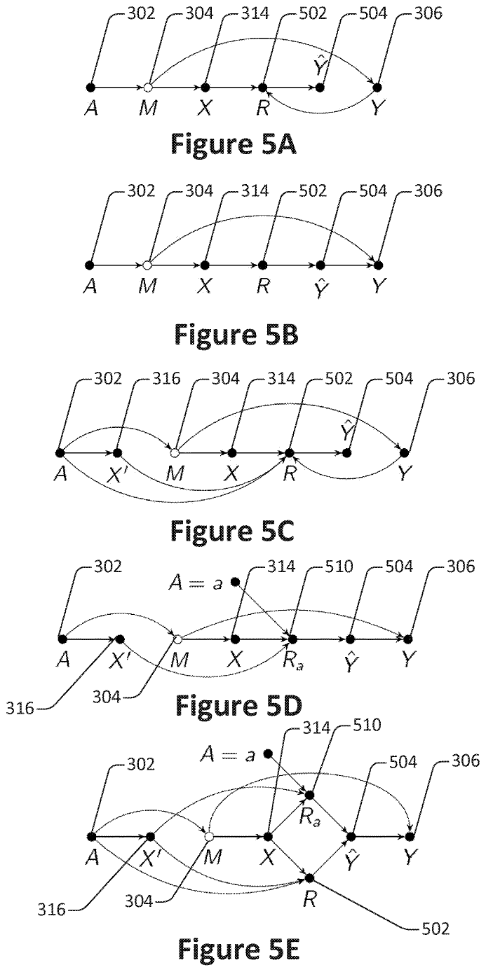

FIG. 5A, FIG. 5B, FIG. 5C, FIG. 5D, and FIG. 5E represent diagrams illustrating how prediction models may be used to predict a target variable, generated in accordance with one or more embodiments.

FIG. 5A represents a training phase using traditional feature data X 314. In FIG. 5A, traditional feature data X 314 is used as a measure for the mediating construct M 304 to train a prediction model to produce a score R 502. The score R 502 is then used to reach a decision Y 504. The training is performed by using observed target outcome values Y 306 to determine the model's parameters. For instance, one or more metrics of model performance may be generated based on a comparison of Ŷ 504 with Y 306. However, alternative data X′ is omitted to avoid training the prediction model to be biased.

FIG. 5B represents an inference phase using traditional data X 314. In FIG. 5B, the prediction model trained in FIG. 5A is applied to the traditional feature data X 314 as a measure for the mediating construct M 304 to produce a score R 502. The score R 502 is then used to reach a decision Ŷ 504. Of course, in some configurations Ŷ 504 may or may not affect Y 306. For instance, making a determination to extend a loan enables the possibility of loan default, whereas making a determination not to extend a loan removes the possibility of loan default.

FIG. 5C represents a training phase using traditional feature data X 314 and alternative feature data X′ 316. In FIG. 5A, both traditional feature data X 314 and alternative feature data X′ 316 are used to train a prediction model to produce a score R 502, even though the alternative feature data X′ 316 may proxy for the protected attribute A 302. To correct for this, and in contrast to FIG. 5A, data representing the protected attribute A 302 is also used to train the model (this is known in causal terminology as a backdoor adjustment). The score R 502 is then used to reach a decision Ŷ 504. The training is performed by using observed target outcome values Y 306 to determine the model's parameters. For instance, one or more metrics of model performance may be generated based on a comparison of Y 504 with Y 306.

FIG. 5D represents an inference phase using traditional feature data X 314 and alternative feature data X′ 316. In FIG. 5D, the prediction model trained in FIG. 5C is applied to the traditional feature data X 314 and alternative feature data X′ 316 to produce a score Rₐ 510. The score Rₐ 510 is then used to reach a decision Ŷ 504. Of course, in some configurations Ŷ 504 may or may not affect Y 306. For instance, making a determination to extend a loan enables the possibility of loan default, whereas making a determination not to extend a loan removes the possibility of loan default. In FIG. 5D, data representing the protected attribute A 302 is omitted. The omitted data may be dropped entirely or may be replaced with a default protected attribute value (in causal terminology this could be considered an intervention with a “do” operator, such as do(A=White) for race or do(A=Male) for gender). For instance, all values for race may be set to a single default value.

FIG. 5E represents an alternative approach to an inference phase using traditional feature data X 314 and alternative feature data X′ 316. In FIG. 5E, the prediction model trained in FIG. 5C is applied to the traditional feature data X 314 and alternative feature data X′ 316 to produce a score Rₐ 510, using a default protected attribute value similar to FIG. 5D. The prediction model trained in FIG. 5C is also applied to the traditional feature data X 314 and alternative data X′ 316, using the actual protected attribute value to produce a score R 502. The score R 502 and the score Rₐ 510 are then compared against each other to reach a decision Ŷ 504. For example, a particular observation may be evaluated to determine whether the score R 502 or the score Rₐ 510 is less discriminatory. The less discriminatory score may then be used to reach the decision Ŷ 504. The less discriminatory score may be selected as, for instance, the better score from the perspective of the applicant in terms of the effect on the decision Ŷ 504.

For clarification, in FIG. 5E, data representing the protected attribute A 302 is omitted when computing the score Rₐ 510, but not when computing the score R 502. The omitted data may be dropped entirely or may be replaced with default data (in causal terminology this could be considered an intervention with a “do” operator, such as do(A=White) for race or do(A=Male) for gender). For instance, all values for race may be set to a single default value.

FIG. 6 illustrates an example of a method 600 for preprocessing supervised machine learning data, performed in accordance with one or more embodiments. According to various embodiments, the method 600 may be performed at any suitable computing device.

A request is received at 602 to prepare training data for supervised machine learning. According to various embodiments, the request may be generated as discussed with respect to operation 406 shown in FIG. 4.

A protected attribute is identified in the training data at 604. According to various embodiments, protected attributes in the training data may be identified based on membership in a set of protected attributes. As discussed herein, which attributes are deemed as protected may be specific to a particular context.

A feature is selected for analysis at 606. According to various embodiments, features may be analyzed in any suitable order, in sequence or in parallel. In some embodiments, all features in the training data may be analyzed. Alternatively, only features that meet some suitable criteria may be analyzed. For instance, features may not be selected for analysis when they are considered traditional data, but may be selected for analysis when they are considered alternative data.

A determination is made at 608 as to whether the feature purely proxies for the protected attribute (in causal terminology, this means that the feature has no causal relationship to the target variable). This would correspond to A′ 312 in FIG. 3F. If it is determined that the feature purely proxies for the selected attribute, then the selected feature is removed from the model and training data at 610.

In some implementations, the determination made at 608 may involve determining one or more characteristics related to the feature and the protected attribute. For example, the determination may involve determining one or more correlations or truth tables between values of the feature and values of the protected attribute. As another example, the determination may involve determining some measure of predictive power, alone or in combination with other features, that the selected feature has in predicting target outcome values.

As one example, an attribute such as hair length may be highly correlated with gender but have very little predictive power in predicting a target outcome such as job performance, and hence be deemed a pure proxy for gender. In contrast, an attribute such as education may be somewhat highly correlated with race but nevertheless may provide significant predictive power in models predicting credit default, and hence be deemed not a pure proxy for race. That is, education may have both a causal effect in predicting credit default, as well as a spurious backdoor effect through race.

According to various embodiments, whether a particular combination of characteristics is deemed to indicate that a feature is a proxy for protected attribute A 302 may be determined by comparing one or more of the characteristics or combinations of characteristics against one or more threshold values. Moreover, different threshold values may be used in different contexts. For example, the predictive power of the model may be generally enhanced by including more features, while bias may be reduced by removing features that more purely proxy for a protected attribute. When evaluating predictive power, operation 608 may be performed in conjunction with one or more operations discussed with respect to the method 700 shown in FIG. 7.

An overlap profile including one or more overlap values between the feature and the protected attribute A 302 is determined at 612. According to various embodiments, the overlap profile may identify instances in which a combination of values occurs. In causal language, this allows us to identify positivity violations.

As a specific example, consider an overlap profile comparing values of gender with values of university institution among a training data set to identify a number and/or percentage of attendees of each institution who are classified as men or women. For many institutions, the overlap values may be high. For example, a training data set may include instances of both men and women who attended Purdue University, with the percentage of men attending the institution being relatively close to 50%. However, for other institutions, the overlap values may be low. For instance, a training data set may include relatively few if any observations in which a man attended a college historically attended only by women, such as Smith College, with the percentage of men attending the institution being relatively close to 0%. Therefore, an algorithm would not be able to isolate the causal effect of one's attendance at Smith College for causing credit default versus its spurious backdoor proxy effect through gender, even if the algorithm had access to the protected attribute.

In some embodiments, a prediction model trained on data values having insufficient overlap may risk creating bias due to overfitting on rare events. For instance, a handful of men who attended a historically women-only college may have an outsized effect on the predictions produced by a model for such individuals. Accordingly, the data may need to be adjusted to preemptively reduce such bias. Insufficient overlap may be referred to as a positivity violation.

At 614, a determination is made as to whether the overlap values exceed a designated threshold. According to various embodiments, the designated threshold may be determined so as to avoid or prevent positivity violations, and may depend on the goals or context associated with the prediction model. For example, higher threshold levels may improve model prediction at the expense of increasing potential bias, while lower threshold levels may reduce potential bias but also model predictive power. In particular embodiments, the designated threshold may depend on any of a variety of characteristics, such as the rarity of other combinations of features in the training data, the number of features included in the training data, and the like.

If one or more of the overlap values fail to exceed a designated threshold, then at 616 the feature values having insufficient overlap are replaced with default feature values. According to various embodiments, various approaches may be used to determine default feature values. For example, feature values with insufficient overlap may be dropped completely and treated as missing. As another example, feature values with insufficient overlap may be replaced with comparable feature values that have sufficient overlap. For instance, a particular educational institution (e.g., Smith College) in an observation may be replaced with a different educational institution of comparable quality and characteristics (e.g., New York University). As yet another example, feature values with insufficient overlap may be replaced with more generalized feature values. For instance, a zip code may be replaced with a city and state, or a particular education institution (e.g., Smith College) may be replaced with a general descriptor (e.g., 4-year college in Massachusetts). The feature value replacement rules used to determine the default values may depend on the particular empirical context. However, any rules applied at 616 to replace feature values may be stored so that the same rules can be applied during the inference phase.

Alternatively, or additionally, a protected attribute feature value may be replaced to eliminate the positivity violation. For instance, a protected attribute feature value may be replaced with an aggregate value. For example, a zip code may contain Whites, Blacks, and Latinos but few if any Asians. In this example, rather than treating each of the racial groups separately, Whites and Asians may be aggregated as one group and Blacks and Latinos aggregated as another group. Such a replacement would then provide the overlap needed to avoid positivity violations. For clarity, a positivity violation may be corrected using one or more feature value replacement rules, one or more protected attribute replacement rules, or a combination thereof.

A determination is made at 618 as to whether to select an additional feature for analysis. In some implementations, as discussed with respect to operation 606, all features in the training data may be analyzed. Alternatively, only features that meet some suitable criteria may be analyzed. For instance, features may not be selected for analysis when they are considered traditional data, but may be selected for analysis when they are considered alternative data.

If no additional feature is selected for analysis, then a determination is made at 620 as to whether to select an additional protected attribute for analysis. According to various embodiments, each protected attribute included in the training data may be analyzed to determine whether to remove proxies and/or determine default data values.

FIG. 7 illustrates an example of a method 700 for evaluating a supervised machine learning model, performed in accordance with one or more embodiments. According to various embodiments, the method 700 may be performed on any suitable computing device.

A request is received at 702 to evaluate an instance of a supervised machine learning model. According to various embodiments, the request may be generated as discussed with respect to operation 406 shown in FIG. 4.

Test data for analysis is determined at 704. According to various embodiments, a training data set may be divided into data used to actively train the model and data used to test the performance of the training. For example, K-fold validation is one such technique. Accordingly, the test data may include any data remaining after applying the training data to train the model.

In some implementations, a test data set may be preprocessed using some or all of the techniques discussed with respect to operation 406 and the method 800 shown in FIG. 8. That is, the same rules used to determine default data values for feature values exhibiting insufficient overlap or positivity violations may be applied to the test data set.

One or more model-level model performance metrics are determined at 706. According to various embodiments, any of a variety of suitable model-level model performance metrics may be determined. Examples of such metrics may include, but are not limited to: accuracy, lift, precision, recall, and area under a receiver operator curve (AUC). Performance metrics may include fairness measures, such as demographic/statistical parity. Such fairness measures may or may not involve controlling for other features, like income.

A protected attribute is selected for analysis at 708. According to various embodiments, each protected attribute included in the test data may be selected for analysis. Attributes may be analyzed in sequence, in parallel, or in any suitable order.

A protected attribute value is selected for analysis at 710. According to various embodiments, protected attribute values selected for analysis may include any values that may be assigned to the protected attribute within the test data set.

One or more attribute-level model performance metrics are determined at 712.

According to various embodiments, the attribute-level performance metrics may include any or all of the model-level performance metrics discussed with respect to the operation 706. In this way, the predictive performance of the model for particular subsets of the data may be determined independently. Moreover, the predictive performance of the model for particular classes may be compared across different instances of the model. For example, the predictive performance of a model for women may be compared before and after adding a particular feature to the model. In such a configuration, the feature may be retained if it generally improves or at least does not harm the predictive performance of the model for values of a protected attribute. In addition, the feature would be retained if it improves fairness, such as reducing relative denial rates between groups, without a significant drop in a performance metric like accuracy.

A determination is made at 714 as to whether to select an additional protected attribute value for analysis. If no additional protected attribute value is selected for analysis, then at 716 a determination is made as to whether to select an additional protected attribute for analysis. As discussed with respect to the operations 708 and 710, any or all of the protected attributes and associated values may be analyzed to determine their contributions to model performance and/or any indications of bias related to the values.

FIG. 8 illustrates an example of a method 800 for applying a supervised machine learning model, performed in accordance with one or more embodiments. According to various embodiments, the method 800 may be used to determine one or more predicted outcome values based on a prediction model trained as described with respect to the method 400 shown in FIG. 4.

A request to apply a supervised machine learning model is received at 802. In some implementations, the request may be received at a computing device. The request may include or reference any or all of the information discussed in FIG. 8.

First, inference data for the supervised machine learning model is identified at 804. In some implementations, the first inference data may include one or more observations similar to those discussed with respect to the training data in FIG. 4. However, an inference observation may include a target value that is not observable.

A determination is made at 806 as to whether the first inference data includes protected attribute values. The determination may be made by analyzing the features reflected in the observations within the inference data. If the first inference data includes protected attribute values, then at 808 the first inference data is used to determine second inference data by updating the first inference data to remove the protected attribute values.

In some embodiments, the operation 808 may involve entirely removing data values corresponding with the protected attribute. For instance, a sex or race parameter in a supervised machine learning model may be dropped entirely.

In some embodiments, the operation 808 may involve replacing data values corresponding with the protected attribute value with default values. For instance, all data values corresponding with gender may be set to either male or female.

In some embodiments, one or more operations shown in FIG. 8, such as 804, 808, and/or 812 may involve imputing one or more values in the training data. For example, a protected attribute value for an observation may be missing in the inference data. Such missingness may be due to lack of availability. Alternatively, a value may be missing because its collection is prohibited by law. In such situations, the imputation technique may infer a suitable value. For example, a technique such as Bayesian Improved Surname Geocoding (BISG) may be used to infer a value for a protected attribute such as race or ethnicity based on a person's last name and zip code.

A determination is made at 810 as to whether the second inference data includes feature data values with insufficient overlap or have a positivity violation. According to various embodiments, the determination may involve analyzing the second inference data to determine whether it includes combinations of feature values identified in FIG. 6 as having insufficient overlap or a positivity violation.

If it is determined that the inference data includes feature data values with insufficient overlap or a positivity violation, then at 812, the inference data is updated to remove the feature data values. According to various embodiments, the operation 812 may involve replacing feature data values having insufficient overlap with substitute values. In some embodiments, the substitute values may be determined as discussed with respect to the method 600 shown in FIG. 6.

At 814, one or more predicted target values are determined for each observation. In some embodiments, one predicted target value may be determined by applying the prediction model determined in FIG. 4 to the first inference data identified at 804. In such an approach, when determining the first one or more predicted target values, the original protected attribute values are used to generate the predicted outcome values.

In some embodiments, another predicted target value may be determined by applying the prediction model determined in FIG. 4 to the second inference data determined as discussed with respect to the operations 808. In such an approach, and in contrast to the approach described in the previous paragraph, the original protected attribute values are not used to generate the predicted outcome values. If no substitute protected attribute values are determined, then the protected attribute values may be omitted entirely. Alternatively, if substitute protected attribute values are determined, then the substitute protected attribute values may be supplied to the supervised machine learning model instead of the original protected attribute values when determining the second one or more predicted target values.

In particular embodiments, more than two predicted target values may be determined.

For example, an observation corresponding to a person may be tested as (1) a black female, (2) a black male, (3) a white female, and (4) a white male. Each of these different observations may lead to a different predicted outcome value.

A debiased predicted value is determined at 816 based on the two or more predicted target values. In some embodiments, determining a debiased predicted value may involve selecting the predicted target value that is least discriminatory. Thus, the selected target values may include one target value for each observation. In the event that the inference data includes multiple observations, the predicted target value for some observations may potentially be drawn from the first inference and data, while the predicted target value for other observations may potentially be drawn from the second inference data.

For example, consider the use of gender in a predictive model used for determining whether to grant a loan application. In such a model, the actual gender of an individual represented by an inference observation may be used in the first inference data, while all individuals may be artificially set to “male” in the second inference data. For a person who is actually male, the same prediction would be generated, and indeed only one prediction may need to be generated for such a person. For a person who is actually female, the prediction produced when using the first inference data (i.e., when the data correctly identifies the person as female) may differ from the prediction produced when using the second inference data (i.e., when the data is artificially set to identify the person as male). In the event of such a disparity, the prediction having the best score from the person's perspective may be selected, since that score may be considered as the least discriminatory.

As another example, consider the use of race in a predictive model used for determining whether to grant admission to a college. In such a model, the actual race of an individual represented by an inference observation may be used in the first inference data, while all individuals may be artificially set to “white” in the second inference data. For a person who is actually white, the same prediction would be generated, and indeed only one prediction may need to be generated for such a person. For a person who is actually non-white, the prediction produced when using the first inference data (i.e., when the data correctly identifies the person as white) may differ from the prediction produced when using the second inference data (i.e., when the data is artificially set to identify the person as white). In the event of such a disparity, the prediction having the best score from the person's perspective may be selected, since that score may be considered as the least discriminatory.

According to various embodiments, determining a debiased predicted value may involve determining a maximum or minimum. For instance, determining a debiased predicted value may involve selecting the largest predicted target value or the smallest predicted target value. As another example, the debiased predicted value may correspond to an outcome having an ordinal ranking, and determining the debiased predicted value may involve selecting a value one or more predicted target values having a most positive ordinal ranking for the designated inference observation. For instance, the most positive ordinal ranking may be the ordinal ranking most likely to lead to a positive decision on a loan application, admissions decision, or the like.

In some embodiments, determining a debiased predicted value may involve applying one or more mathematical operations to one or more predicted target values. For instance, an adjustment formula may be applied. Such an adjustment formula may, for example, control for confounding bias. As one example, determining a debiased predicted value may involve determining an average between different predicted target values. The average may be weighted or unweighted. A weighted average may be weighted by, for instance, the proportion of a population represented by different protected attribute values. For instance, consider an observation for which a target value of Y_{A=male} is predicted by setting a protected attribute sex equal to male and a target value of Y_{A=female} is predicted by setting a protected attribute sex equal to female, in a population where 40% of individuals are male. In such a situation, the debiased predicted value may be calculated as Yₚ=0.4* Y_{A=male}+0.6* Y_{A=female}. More generally, the debiased predicted value may be calculated based on the following formula, where A is the protected attribute, a is a particular protected attribute value, and Ŷₐ is the predicted target value when A=a.

$$\hat{Y} = {\sum }_{a} {\hat{Y}}_{a} * P ( A = a )$$

Various other mathematical operations may be employed instead of, or in addition to, the preceding formula. For example, the proportion of a population having a particular protected attribute value may be assumed, for instance in a population where the proportional representation is unknown. As another example, weights may be adjusted to, for example, boost predictions for groups of individuals historically subject to discrimination. As yet another example, inverse probability weighting may be used. Examples of suitable operations that may be employed may include, but are not limited to: matching, stratification, regression adjustment, doubly robust estimation, instrumental variables analysis, and G-methods.

The debiased predicted value are stored at 818. According to various embodiments, the debiased predicted target value may be stored on any suitable storage device.

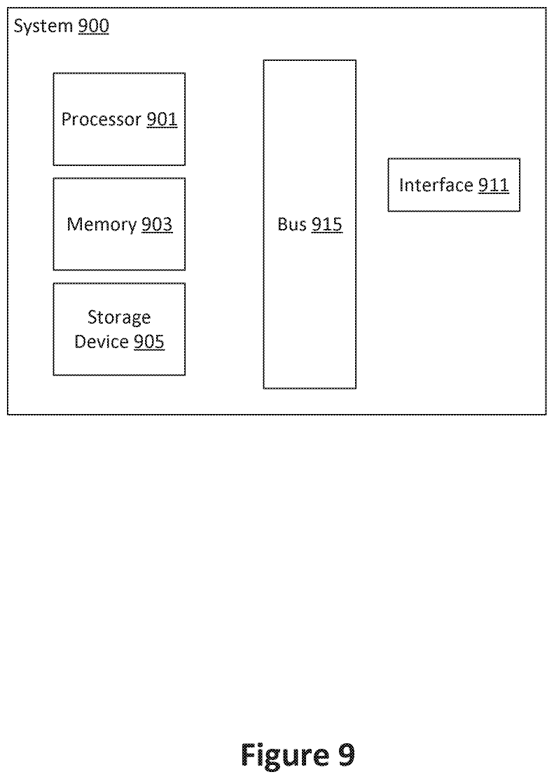

FIG. 9 illustrates one example of a computing device. According to various embodiments, a system 900 suitable for implementing embodiments described herein includes a processor 901, a memory module 903, a storage device 905, an interface 911, and a bus 915 (e.g., a PCI bus or other interconnection fabric.) System 900 may operate as a variety of devices such as computing device configured to perform data analysis, a cloud computing system configured to perform data analysis, or any other device or service described herein. Although a particular configuration is described, a variety of alternative configurations are possible. The processor 901 may perform operations such as those described herein (this could include CPUs, GPUs, TPUs, or some combination, for example). Instructions for performing such operations may be embodied in the memory 903, on one or more non-transitory computer readable media, or on some other storage device. Various specially configured devices can also be used in place of or in addition to the processor 901. The interface 911 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

In some embodiments, the training data set may be partitioned to train multiple models for different segments of the data. Then, during inference, the multiple models may each be applied to the same inference observation and combined, for instance via weighting, to produce a debiased prediction. Partitioning the training data by protected attribute values and training separate model portions on each partition allows the learning process to condition explicitly on those attributes, rather than allowing their effects to remain latent and entangled with other features. In a conventional single-model approach, correlations between features and outcomes may arise partly from indirect pathways through protected attributes (for example, where a feature serves as a proxy). Because the model is trained on pooled data, it cannot reliably distinguish whether a predictive relationship reflects a legitimate causal mechanism or a spurious association mediated by the protected attribute. Partitioning addresses this by isolating the training data into homogeneous subsets, ensuring that each model portion learns relationships within a fixed protected attribute context.

In some embodiments, the partitioning approach of creating multiple models and applying them to a single inference observation effectively implements a backdoor adjustment in a concrete and operational way. Each model portion approximates the conditional relationship between features and outcomes given a specific value of the protected attribute or combination of values across multiple protected attributes. By training within partitions, the model blocks confounding paths that would otherwise pass through the protected attribute, because that attribute is held constant within each subset. As a result, the learned mappings reflect within-group dependencies rather than mixed signals that combine causal and proxy effects. This is functionally equivalent to conditioning on the protected attribute in a causal framework to remove bias introduced by confounders.

In some embodiments, the use of multiple models further enables the system to simulate counterfactual scenarios at inference time. When an observation is evaluated across all model portions, each model produces a prediction corresponding to a different hypothetical assignment of the protected attribute. This generates a set of counterfactual predictions representing how the outcome would change if the same individual were associated with different protected attribute values. Combining these predictions-such as through weighted averaging-yields a final estimate that integrates across these scenarios, thereby removing dependence on any single protected attribute realization while preserving relevant structural information.

In some embodiments, this partitioned approach enforces the backdoor adjustment structurally rather than relying on a single model to learn it implicitly. In a unified model, even if protected attributes are included, there is no guarantee that the model will correctly disentangle causal and spurious relationships, particularly in the presence of limited data or strong correlations. Partitioning eliminates this ambiguity by separating the learning problem into distinct, well-defined subproblems, each of which is simpler and less confounded. The aggregation step then becomes an explicit and controllable mechanism for recombining these deconfounded estimates.

In some embodiments, the partitioned approach also improves robustness and fairness simultaneously. By allowing each partition-specific model to fully utilize features that may otherwise be excluded due to proxy concerns, the system retains predictive power. At the same time, because predictions are generated across all protected attribute scenarios and then combined, no single biased pathway dominates the final outcome. The result is a model that leverages rich feature information while systematically neutralizing the influence of protected attributes through an explicit, causally grounded adjustment process.

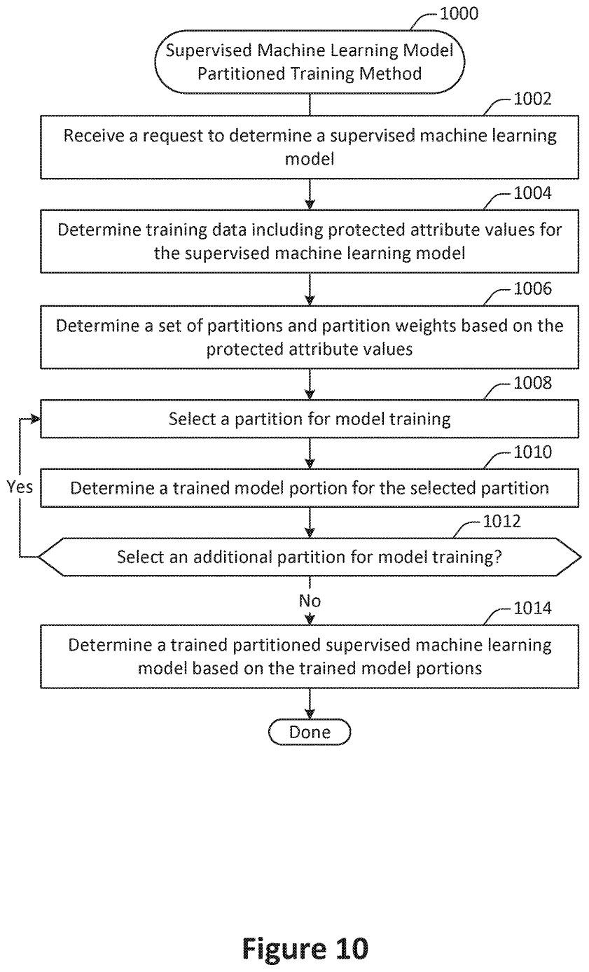

FIG. 10 illustrates one example of a supervised machine learning model partitioned training method 1000, performed in accordance with one or more embodiments. The method 1000 may be used to train a plurality of model portions associated with different partitions of a training data set defined with respect to protected attribute values. The resulting model portions may subsequently be combined or weighted during inference to produce predictions that reduce bias associated with protected attributes while preserving predictive power.

A request to determine a supervised machine learning model is received at 1002. According to various embodiments, the request may be generated manually or automatically. For example, the request may be generated in response to a user instruction to train a prediction model for a specified prediction task such as predicting credit default, job performance, educational performance, or other target outcomes. The request may identify the training data set, the target variable, one or more protected attributes, and optionally a type of supervised machine learning model to be trained.

Training data including protected attribute values for the supervised machine learning model is determined at 1004. According to various embodiments, the training data may include a plurality of observations corresponding with units of analysis such as individuals or organizations. Each observation may include a target value, a plurality of feature values, and one or more protected attribute values. The protected attribute values may correspond to characteristics such as race, ethnicity, gender, age, or other attributes for which bias reduction is desired.

A set of partitions and partition weights are determined at 1006 based on the protected attribute values. According to various embodiments, the training data may be divided into multiple partitions corresponding with different values or combinations of values associated with one or more protected attributes. For example, partitions may correspond to groups such as male and female, or may correspond to combinations such as Black female, Black male, White female, and White male. In some implementations, partition weights may be determined based on the relative frequency of observations within each partition, the relative importance of particular groups, or other criteria designed to address bias or fairness considerations.

According to various embodiments, a partition may refer to a subset of the training data that is defined based on one or more values of one or more protected attributes. Each partition may include the observations in the training data that share the same protected attribute value or combination of protected attribute values. In this way, the full training data set may be divided into multiple partitions such that each observation belongs to exactly one partition. Training separate model portions using these partitions may allow the prediction model to learn relationships between features and outcomes that differ across groups associated with different protected attribute values.

In some implementations, partitions may also be defined using more generalized or aggregated categories of protected attribute values. For example, several protected attribute values may be grouped together to form a single partition when the number of observations associated with a particular value is relatively small. As one example, individuals associated with several related ethnic categories may be combined into a single partition representing a broader ethnic group. In another example, partitions may be defined using derived or inferred protected attribute values, such as values imputed based on other features within the training data. In this way, partitions may be defined flexibly depending on the structure of the available data and the objectives of the prediction model.

In the case of a continuous protected attribute, such as age, partitioning may be performed through bucketing. For example, the data may be divided into age partitions such as 25-35 years old, 35-45 years old, etc. Such buckets may be predefined or may be dynamically determined using a statistical method. For instance, the buckets may be determined by clustering, by evenly dividing the training data into a predetermined number of partitions, or by another mechanism.

In some embodiments, partition weights may be determined based on the relative prevalence of the protected attribute values in the training data. For example, if 60% of the observations correspond to individuals having a first protected attribute value and 40% correspond to individuals having a second protected attribute value, the partitions may be assigned corresponding weights of 0.6 and 0.4. During inference, predicted outcome values generated by the model portions corresponding with these partitions may be combined using these weights to approximate predictions that reflect the overall population distribution represented in the training data.

In other embodiments, partition weights may be determined based on demographic or policy considerations rather than solely on the distribution of the training data. For example, in situations where a protected group is historically underrepresented in the training data, the partition weight for that group may be increased relative to its observed frequency in order to mitigate historical imbalance. As one example, a training data set in which 80% of the observations correspond to a first group and 20% correspond to a second group may nevertheless assign partition weights of 0.5 and 0.5 to ensure that both groups contribute equally to predicted outcomes. In another example, partition weights may be determined using externally supplied demographic statistics corresponding with a broader population rather than the specific training data set.

In still other embodiments, partition weights may be determined based on model performance characteristics associated with the different partitions. For example, if the trained model portion associated with one partition exhibits higher predictive accuracy than the model portion associated with another partition, the partition weights may be adjusted to account for differences in predictive reliability. Alternatively, partition weights may be determined using optimization techniques designed to minimize a fairness metric, reduce disparate impact, or balance predictive accuracy across groups.

A partition is selected for model training at 1008. According to various embodiments, partitions may be selected sequentially or according to any suitable selection strategy. For example, the method may iterate through each partition defined by the protected attribute values until model portions have been trained for all partitions.

A trained model portion for the selected partition is determined at 1010. According to various embodiments, the trained model portion may be produced by training a supervised machine learning model using only the subset of training observations associated with the selected partition. In this way, the model portion may capture relationships between the feature values and the target variable that are specific to the corresponding protected attribute group.

Any suitable supervised machine learning technique may be employed, including regression models, decision trees, gradient boosting models, neural networks, or ensemble models.

A determination is made at 1012 as to whether to select an additional partition for model training. If additional partitions remain, then another partition is selected at 1008 and the operations for training a corresponding model portion are repeated.

If no additional partitions are selected, then a trained partitioned supervised machine learning model is determined at 1014 based on the trained model portions. According to various embodiments, the trained partitioned model may include a plurality of model portions corresponding with the respective partitions along with the associated partition weights. The partition weights may later be used during inference to combine predictions generated by the model portions. In some implementations, the trained partitioned model may be stored on a storage device so that it may subsequently be applied to inference observations to determine predicted outcome values in a manner that reduces bias associated with protected attributes.

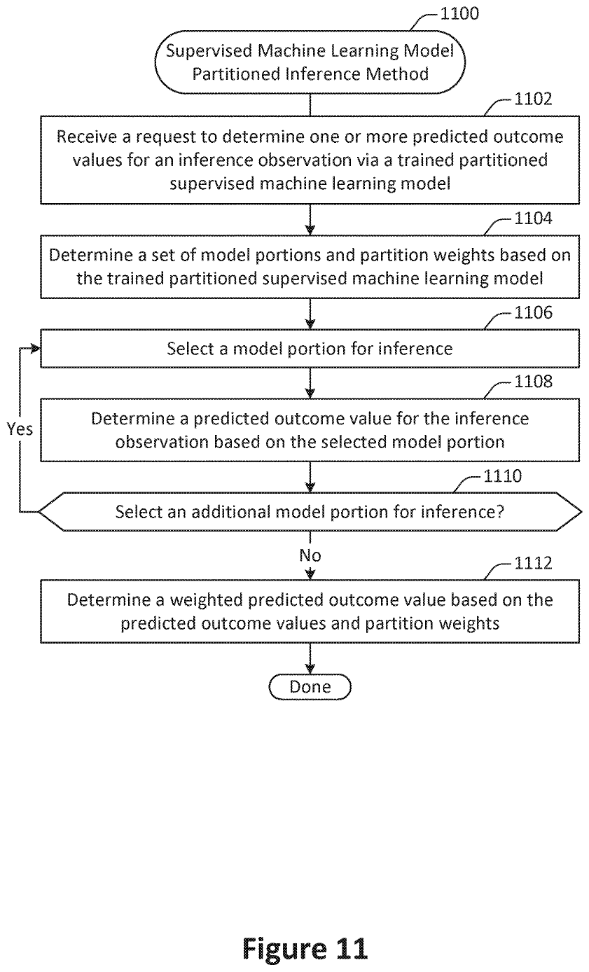

FIG. 11 illustrates one example of a supervised machine learning model partitioned inference method 1100, performed in accordance with one or more embodiments. The method 1100 may be used to determine predicted outcome values for an inference observation by applying a trained partitioned supervised machine learning model, determined as discussed with respect to FIG. 10, that includes a plurality of model portions and associated partition weights.

In this way, predictions may be generated using model portions associated with different protected attribute partitions and then combined in a manner that reduces bias while maintaining predictive accuracy.

A request to determine one or more predicted outcome values for an inference observation via a trained partitioned supervised machine learning model is received at 1102. According to various embodiments, the request may be generated manually or automatically.

For example, the request may correspond to a request to evaluate a loan application, an employment candidate, a college applicant, or another entity for which a predicted outcome value is to be determined. The request may include or reference an inference observation including one or more feature values corresponding with the features used to train the supervised machine learning model.

A set of model portions and partition weights are determined at 1104 based on the trained partitioned supervised machine learning model. According to various embodiments, the trained partitioned model may include a plurality of model portions corresponding with different partitions defined with respect to one or more protected attribute values, along with associated partition weights. The partition weights may reflect, for example, population distributions, fairness considerations, or model performance characteristics determined during the training process. The model portions and partition weights may be retrieved from where they were stored upon being determined as discussed with respect to FIG. 10.

A model portion is selected for inference at 1106. According to various embodiments, the model portions may be selected sequentially or in any suitable order. In some implementations, each model portion corresponding with a partition may be applied to the inference observation to generate a predicted outcome value. For example, if the partitions correspond to different protected attribute values such as race or gender, the inference observation may be evaluated using each of the model portions associated with those partitions.

A predicted outcome value for the inference observation is determined based on the selected model portion at 1108. According to various embodiments, determining the predicted outcome value may involve applying the selected model portion to the feature values associated with the inference observation. Each model portion may produce a predicted outcome value representing, for example, a probability of credit default, a predicted level of job performance, a likelihood of college success, or another outcome corresponding with the prediction task.

In some embodiments, the predicted outcome values generated by the different model portions may correspond to hypothetical scenarios in which the inference observation is evaluated as belonging to different protected attribute groups. For example, consider a credit approval model partitioned by gender. One model portion may generate a predicted probability of default for the inference observation when evaluated using the model trained on observations corresponding to male individuals, while another model portion may generate a predicted probability of default using the model trained on observations corresponding to female individuals. In another example, if the partitions correspond to racial groups such as White, Black, Asian, and Hispanic, separate predicted outcome values may be generated by applying the inference observation to the model portions trained on each of those partitions, regardless of the actual protected attribute value for the inference observation or observations.

In some implementations, partitions may correspond to combinations of protected attributes, and predicted outcome values may be generated for each such combination. For example, if the partitions correspond to combinations of race and gender, predicted outcome values may be generated for the inference observation using model portions corresponding to partitions such as White male, White female, Black male, and Black female. In this way, the prediction process may evaluate how the inference observation would be assessed under multiple protected attribute scenarios, even when the actual protected attribute value of the observation is unknown, unavailable, or intentionally omitted from the inference process.

A determination is made at 1110 as to whether to select an additional model portion for inference. If additional model portions remain to be applied, then another model portion is selected at 1106 and an additional predicted outcome value is determined at 1108.

If no additional model portions remain, then at 1112 a weighted predicted outcome value is determined based on the predicted outcome values and the partition weights. According to various embodiments, the predicted outcome values generated by the different model portions may be combined using the partition weights determined during training. For example, a weighted average of the predicted outcome values may be calculated, with each predicted value multiplied by the corresponding partition weight. In this way, the final predicted outcome value may reflect contributions from each partition-specific model portion in a manner consistent with the weighting scheme used to address bias and fairness considerations.

In some embodiments, the weighting operation may correspond to examples similar to those described with respect to partition weights determined during training. For instance, if the partition weights correspond to the relative frequency of protected attribute groups in a population, predicted outcome values generated by model portions corresponding to those groups may be combined according to those frequencies. As one example, if the population distribution includes 60% individuals associated with a first protected attribute value and 40% individuals associated with a second protected attribute value, the predicted outcome values produced by the corresponding model portions may be combined using weights of 0.6 and 0.4.

In other embodiments, partition weights may reflect fairness objectives or policy considerations. For example, predicted outcome values generated by model portions corresponding to historically disadvantaged groups may be assigned higher weights than those corresponding to more advantaged groups. As another example, predicted outcome values generated by different model portions may be combined using equal weights so that each partition contributes equally to the final prediction regardless of the representation of the partition within the training data. The resulting weighted predicted outcome value may then be returned or stored as the prediction for the inference observation.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A computer-implemented method for reducing bias in machine learning predictions, the method comprising:
receiving, by one or more processors, training data comprising a plurality of training observations, each training observation including (i) a target value, (ii) a plurality of feature values corresponding to a plurality of features, and (iii) at least one protected attribute value corresponding to at least one protected attribute;
determining, based on the at least one protected attribute value, a plurality of partitions of the training data and a corresponding plurality of partition weights, each partition corresponding to a different protected attribute value or combination of protected attribute values;
training, using the plurality of partitions, a partitioned supervised machine learning model that includes a plurality of model portions respectively associated with the plurality of partitions, wherein each model portion is trained on training observations assigned to the corresponding partition;
receiving an inference observation comprising a plurality of inference feature values corresponding to the plurality of features;
applying the plurality of model portions to the inference observation to determine a plurality of predicted outcome values for the inference observation, each predicted outcome value being generated by a different one of the plurality of model portions and corresponding to evaluation of the inference observation with respect to a different protected attribute scenario represented by the corresponding partition;
determining, based on the plurality of predicted outcome values and the plurality of partition weights, a weighted predicted outcome value for the inference observation, wherein the weighted predicted outcome value is determined by combining the plurality of predicted outcome values according to the plurality of partition weights such that the weighted predicted outcome value reflects contributions from the different protected attribute scenarios; and
storing or outputting the weighted predicted outcome value for use in controlling a downstream decision process.

2. The method of claim 1, wherein determining the plurality of partitions comprises defining each partition based on a distinct value of at least one protected attribute.

3. The method of claim 1, wherein determining the plurality of partitions comprises defining at least some partitions based on combinations of values of two or more protected attributes.

4. The method of claim 1, wherein the plurality of partition weights are determined based on relative frequencies of the corresponding partitions within the plurality of training observations.

5. The method of claim 1, wherein the plurality of partition weights are determined based on externally supplied demographic information corresponding to a population associated with the machine learning predictions.

6. The method of claim 1, wherein determining the weighted predicted outcome value comprises determining a weighted average of the plurality of predicted outcome values using the plurality of partition weights.

7. The method of claim 1, wherein training the partitioned supervised machine learning model comprises training each model portion using only training observations associated with the corresponding partition.

8. The method of claim 1, wherein the protected attribute corresponds to at least one of race, ethnicity, gender, age, disability status, national origin, or religion.

9. The method of claim 1, wherein the downstream decision process corresponds to at least one of determining whether to extend credit, determining whether to admit an applicant to an educational institution, determining whether to extend an employment offer, or determining a pricing or risk assessment associated with an individual.

10. The method of claim 1, wherein determining the plurality of partitions further comprises aggregating two or more protected attribute values into a common partition when a number of training observations associated with at least one of the protected attribute values falls below a designated threshold.

11. The method of claim 1, wherein determining the plurality of partition weights comprises adjusting at least one partition weight to increase a contribution of a partition associated with a historically disadvantaged protected attribute group.

12. The method of claim 1, wherein applying the plurality of model portions to the inference observation comprises generating predicted outcome values corresponding to hypothetical assignments of the inference observation to different protected attribute values.

13. The method of claim 1, wherein the partitioned supervised machine learning model comprises at least one of a regression model, a decision tree model, a gradient boosting model, a neural network model, or an ensemble model.

14. The method of claim 1, further comprising normalizing the plurality of predicted outcome values prior to determining the weighted predicted outcome value.

15. A system including one or more processors configured to perform a method for reducing bias in machine learning predictions, the method comprising:
receiving, by the one or more processors, training data comprising a plurality of training observations, each training observation including (i) a target value, (ii) a plurality of feature values corresponding to a plurality of features, and (iii) at least one protected attribute value corresponding to at least one protected attribute;
determining, based on the at least one protected attribute value, a plurality of partitions of the training data and a corresponding plurality of partition weights, each partition corresponding to a different protected attribute value or combination of protected attribute values;
training, using the plurality of partitions, a partitioned supervised machine learning model that includes a plurality of model portions respectively associated with the plurality of partitions, wherein each model portion is trained on training observations assigned to the corresponding partition;
receiving an inference observation comprising a plurality of inference feature values corresponding to the plurality of features;
applying the plurality of model portions to the inference observation to determine a plurality of predicted outcome values for the inference observation, each predicted outcome value being generated by a different one of the plurality of model portions and corresponding to evaluation of the inference observation with respect to a different protected attribute scenario represented by the corresponding partition;
determining, based on the plurality of predicted outcome values and the plurality of partition weights, a weighted predicted outcome value for the inference observation, wherein the weighted predicted outcome value is determined by combining the plurality of predicted outcome values according to the plurality of partition weights such that the weighted predicted outcome value reflects contributions from the different protected attribute scenarios; and
storing or outputting the weighted predicted outcome value for use in controlling a downstream decision process.

16. The system of claim 15, wherein determining the plurality of partitions comprises defining each partition based on a distinct value of at least one protected attribute.

17. The system of claim 15, wherein determining the plurality of partitions comprises defining at least some partitions based on combinations of values of two or more protected attributes.

18. The system of claim 15, wherein the plurality of partition weights are determined based on relative frequencies of the corresponding partitions within the plurality of training observations.

19. The system of claim 15, wherein the plurality of partition weights are determined based on externally supplied demographic information corresponding to a population associated with the machine learning predictions.

20. One or more non-transitory computer readable media having instructions stored thereon for performing a method for reducing bias in machine learning predictions, the method comprising:
receiving, by one or more processors, training data comprising a plurality of training observations, each training observation including (i) a target value, (ii) a plurality of feature values corresponding to a plurality of features, and (iii) at least one protected attribute value corresponding to at least one protected attribute;
determining, based on the at least one protected attribute value, a plurality of partitions of the training data and a corresponding plurality of partition weights, each partition corresponding to a different protected attribute value or combination of protected attribute values;
training, using the plurality of partitions, a partitioned supervised machine learning model that includes a plurality of model portions respectively associated with the plurality of partitions, wherein each model portion is trained on training observations assigned to the corresponding partition;
receiving an inference observation comprising a plurality of inference feature values corresponding to the plurality of features;
applying the plurality of model portions to the inference observation to determine a plurality of predicted outcome values for the inference observation, each predicted outcome value being generated by a different one of the plurality of model portions and corresponding to evaluation of the inference observation with respect to a different protected attribute scenario represented by the corresponding partition;
determining, based on the plurality of predicted outcome values and the plurality of partition weights, a weighted predicted outcome value for the inference observation, wherein the weighted predicted outcome value is determined by combining the plurality of predicted outcome values according to the plurality of partition weights such that the weighted predicted outcome value reflects contributions from the different protected attribute scenarios; and
storing or outputting the weighted predicted outcome value for use in controlling a downstream decision process.
